(19) United States
(12) Patent Application Publication
(10) Pub. No.: US 2017/0046153 A1
(43) Pub. Date: Feb. 16, 2017

(54) SIMD MULTIPLY AND HORIZONTAL REDUCE OPERATIONS

(71) Applicant: QUALCOMM Incorporated, San Diego, CA (US)

(72) Inventor: Eric Wayne MAHURIN, Austin, TX (US)

(21) Appl. No.: 14/826,196

(22) Filed: Aug. 14, 2015

(51) Int. Cl. G06F 9/30

(52) U.S. Cl. CPC G06F 9/3001

(57) ABSTRACT

Systems and methods relate to multiply-and-horizontal-reduce operations, implemented in a digital filter, for example. A single instruction multiple data (SIMD) instruction comprising a first vector comprising M+C multiplicand elements, wherein M and C are positive integers and a second vector comprising M+C corresponding multiplier elements, wherein the C multiplier elements have a value of 1, is received. Using M multipliers in a processor, M multiplications of M multiplicand elements with corresponding M multiplier elements which do not include the C multiplier elements whose values are 1, are performed to generate M products. The C multiplicand elements whose corresponding C multiplier elements have values of 1 are added to or vertically accumulated with the M products.

### FIELD OF DISCLOSURE

Aspects of this disclosure pertain to reducing computational complexity and increasing efficiency of certain multiply and horizontal reduce operations. More specifically, an exemplary aspect pertains to a single instruction multiple data (SIMD) implementation of a multiply and horizontal reduce operation.

### BACKGROUND

Single instruction multiple data (SIMD) instructions may be used in processing systems for exploiting data parallelism. Data parallelism exists when a same or common task needs to be performed on two or more data elements of a data vector, for example. Rather than use multiple instructions, the common task may be performed on the two or more data elements in parallel by using a single SIMD instruction which defines the same instruction to be performed on multiple data elements in corresponding multiple SIMD lanes.

SIMD instructions may be used to implement certain functions of digital signal processing such as a convolution, digital filters, discrete Fourier transforms (DFTs), discrete cosine transforms (DCTs), etc., wherein a series of signal samples are weighted or multiplied by corresponding coefficients and the results are accumulated or summed up. Thus, SIMD instructions may be used to perform multiplication and horizontal reduction operations to implement these functions. For example, data elements of one vector may be multiplied by corresponding coefficient values provided in another vector, to generate a resulting vector of product terms, which may be added together or reduced in a subsequent operation to provide a desired multiply-and-horizontal-reduce result.

Consider, for example, a SIMD operation used to perform a multiply-and-horizontal-reduce operation on three terms. A first vector operand may be provided with three data elements, X, Y, and Z and a second vector operand may be provided with corresponding three coefficients c1, c2, and c3. The SIMD operation may be implemented by using three multipliers to compute the products of the data elements in the first vector with corresponding coefficients in the second vector, i.e., X*c1, Y*c2, and Z*c3 in parallel, and then add the products together or “reduce” them in an accumulator (e.g., which includes compressors and adders) to obtain the result X*c1+Y*c2+Z*c3.

In some cases encountered in digital signal processing, one of the coefficients (e.g., c3) may be “1,” which may also be an implied value of “1,” based on the nature of the computation involved. For example, a coefficient of “1” may be a normalized value which may occur in a sliding window of coefficients applied to signal samples.

Processors configured to support SIMD operations may have the functionality to support a certain number of parallel operations. The number of parallel operations supported may be a power-of-two in conventional implementations. For example, two multipliers to perform two multiplications in parallel may be available in a conventional processor used to implement the above SIMD operation, along with a capacity for horizontal reduction of two elements (e.g., products or outputs of the four multiplications).

With reference to FIG. 1A, conventional SIMD logic 100 is shown to support two parallel multiplications followed by a horizontal reduction of the two product terms. Thus, data elements X and Y, along with corresponding coefficients c1 and c2 may be made available to a first SIMD instruction 102, wherein the logic 100 performs the computation of X*c1 and Y*c2 in parallel, and the product terms X*c1 and Y*c2 are added or reduced to obtain a first result (not specifically illustrated). A second SIMD instruction 104 then receives the remaining data element Z with corresponding coefficient 1. However, in order to utilize the available logic, a dummy term is calculated. As shown, the product terms Z*1 and dummy term Q*0 are calculated, wherein effectively, Q*0 is simply a multiplication operation of any term with 0, which yields 0. The sum of Z*1+Q*0 is also calculated to complete the multiply-and-horizontal reduce operation. In an effort to fully utilize the available logic 100, the conventional implementation involves multiplication of Z with 1, as well as, multiplication of Q with 0, along with the subsequent addition/reduction processes, which result in increased power consumption.

Another conventional processor which can implement the above SIMD operation may have four multipliers, along with the capacity to horizontally reduce four elements (e.g., products of the four multiplications). For example, with reference to FIG. 1B, SIMD logic 101 which may be present in such a conventional processor is shown. SIMD logic 101 can support four parallel multiplications followed by a horizontal reduction of the four product terms. In this case, SIMD instruction 106 may be used which receives the three data elements X, Y, and Z, along with corresponding coefficients c1, c2, and c3. However, once again, a dummy calculation of Q*0 is performed to utilize the fourth multiplier, and the horizontal reduction is effectively performed to compute X*c1+Y*c2+Z*1+Q*0.

Accordingly, in both conventional implementations represented by SIMD logic 100 and 101 which utilize the available SIMD logic and reduction lanes, unnecessary power consumption is incurred for calculation of the terms Z*1 and Q*0 using multipliers and their subsequent reduction using accumulators, compression hardware, adders, etc.

Thus, there is a need to avoid inefficiencies and wastage of power/computational resources in SIMD multiply-and-horizontal-reduce operations.

### SUMMARY

Exemplary aspects relate to multiply-and-horizontal-reduce operations, implemented in a digital filter, for example. A single instruction multiple data (SIMD) instruction comprising a first vector comprising M+C multiplicand elements, wherein M and C are positive integers and a second vector comprising M+C corresponding multiplier elements, wherein the C multiplier elements have a value of 1, is received. Using M multipliers in a processor, M multiplications of M multiplicand elements with corresponding M multiplier elements which do not include the C multiplier elements whose values are 1, are performed to generate M products. The C multiplicand elements whose corresponding C multiplier elements have values of 1 are added to or vertically accumulated with the M products.

For example, an exemplary aspect relates to method of performing a multiply-and-horizontal-reduce operation, the method comprising: receiving a single instruction multiple data (SIMD) instruction comprising a first vector comprising M+C multiplicand elements, wherein M and C are positive integers, and a second vector comprising M+C corresponding multiplier elements, wherein C multiplier elements have a value of 1. The method includes executing, using M multipliers, M multiplications of M multiplicand elements with corresponding M multiplier elements which do not include the C multiplier elements whose values are 1, to generate M products, and adding C multiplicand elements whose corresponding C multiplier elements have a value of 1 to the M products to generate a result of the SIMD instruction.

Another exemplary aspect relates to apparatus comprising logic configured to receive a single instruction multiple data (SIMD) instruction first vector comprising M+C multiplicand elements, wherein M and C are positive integers, and a second vector comprising M+C corresponding multiplier elements, wherein C multiplier elements have a value of 1. M multipliers are configured to execute M multiplications of M multiplicand elements with corresponding M multiplier elements which do not include the C multiplier elements whose values are 1, to generate M products. A vertical accumulator is configured to add C multiplicand elements whose corresponding multiplier elements have a value of 1 to the M products to generate a result of the SIMD instruction.

Yet another exemplary aspect is directed to a system comprising: means for receiving a single instruction multiple data (SIMD) instruction first vector comprising M+C multiplicand elements, wherein M and C are positive integers, and a second vector comprising M+C corresponding multiplier elements, wherein C multiplier elements have a value of 1, means for executing M multiplications of M multiplicand elements with corresponding M multiplier elements which do not include the C multiplier elements whose values are 1, to generate M products, and means for adding C multiplicand elements whose corresponding multiplier elements have a value of 1 to the M products to generate a result of the SIMD instruction.

Yet another exemplary aspect is directed to a non-transitory computer-readable storage medium comprising instructions executable by a processor, which when executed by the processor cause the processor to perform a multiply-and-horizontal-reduce operation, the non-transitory computer-readable storage medium comprising code for receiving a single instruction multiple data (SIMD) instruction first vector comprising M+C multiplicand elements, wherein M and C are positive integers, and a second vector comprising M+C corresponding multiplier elements, wherein C multiplier elements have a value of 1, code for executing, using M multipliers, M multiplications of M multiplicand elements with corresponding M multiplier elements which do not include the C multiplier elements whose values are 1, to generate M products, and code for adding C multiplicand elements whose corresponding C multiplier elements have a value of 1 to the M products to generate a result of the SIMD instruction.

### BRIEF DESCRIPTION OF THE DRAWINGS

The accompanying drawings are presented to aid in the description of aspects of the invention and are provided solely for illustration of the aspects and not limitation thereof.

FIGS. 1A-B illustrate conventional implementations of multiply-and-horizontal reduce operations.

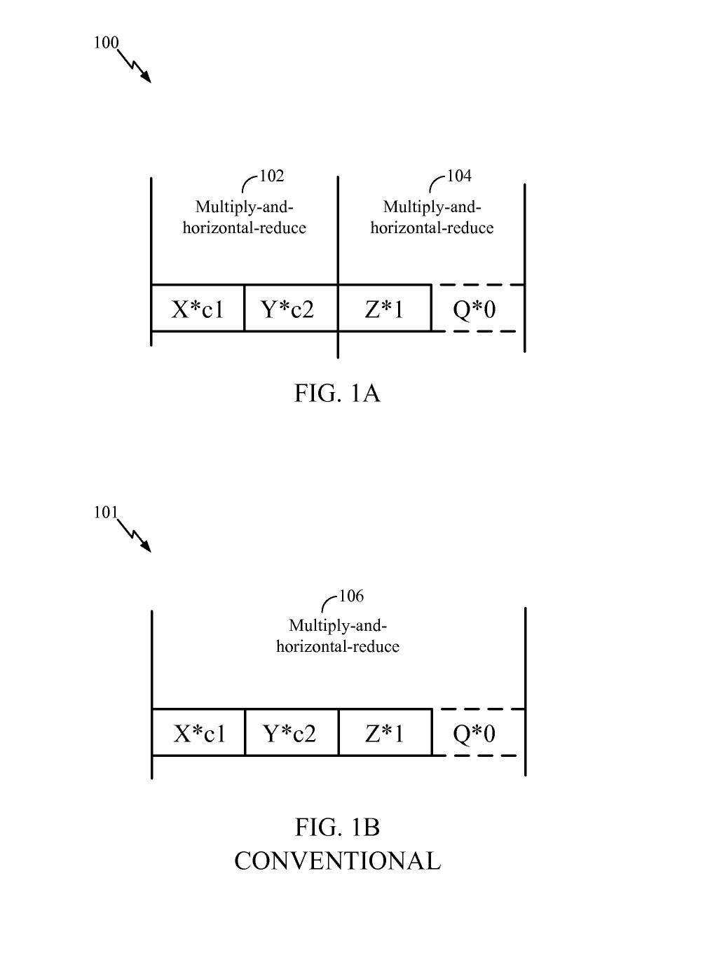

FIGS. 2A-B illustrate exemplary implementations of multiply-accumulate-and-reduce operations.

FIG. 3 illustrates logic configured to implement multiply-accumulate-and-reduce operations using a SIMD instruction according to exemplary aspects.

FIG. 4 illustrates a method of performing a multiply-accumulate-and-reduce operation according to exemplary aspects.

FIG. 5 illustrates an exemplary wireless device 500 in which an aspect of the disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects of this disclosure relate to efficient implementations of multiply-and-horizontal-reduce operations by avoiding unnecessary computations that are seen in conventional implementations described above. For example, when a number of terms are made available for a multiply-and-horizontal-reduce operation wherein the coefficient of one or more of the terms is 1, exemplary SIMD instructions convert the multiply-and-horizontal-reduce operation to a multiply-accumulate-and-reduce operation or a multiply-add-and-reduce, wherein the terms whose coefficient are 1 (e.g., data element Z in the above description) are added to the remaining product terms, without being multiplied by 1 in a multiplier first. Moreover, addition of dummy terms such as Q*0 is also avoided.

Horizontal reduction in this manner, is contrasted with vertical accumulation as known in the art. While horizontal reduction, as described herein, pertains to adding elements (e.g., products of multiplications) from two or more SIMD lanes, vertical accumulation can include addition of elements within the same SIMD lane. For example, in a multiply-accumulate operation, as known in the art, a product of a multiplication is added to an accumulator value, wherein the addition with the accumulator value is a vertical accumulation or vertical reduction. In contrast, a multiply-and-horizontal-reduce operation pertains to horizontal reduction or adding multiplication products from two or more SIMD lanes.

In exemplary aspects, any number of multipliers may be available (e.g., in an exemplary processor) to perform parallel multiplication operations; but for the sake of description of the exemplary aspects, a power-of-2 or 2̂N multipliers, wherein n is a positive integer, are assumed to be present. An operation that can be implemented according to exemplary techniques can involve a multiply-and-horizontal-reduction of two or more multiplications wherein one or more multiplications involve a multiplication by 1 (i.e., multiplication of a data element with 1). For the multiplications which involve a multiplication by 1, use of a multiplier can be avoided. Rather, the intended multiplications can be replaced by addition operations. This allows multiply-and-horizontal-reduce operations to be performed on more terms than there are SIMD lanes or parallel multiplication logic. In some cases, less than all available multipliers available for parallel operations can be utilized if a multiply-and-horizontal-reduce operation is to be performed a number of terms equal to the number of SIMD lanes, but one or more of those terms are multiplication by 1, providing the opportunity to replace those multiplications by 1, with addition operations.

In this description, the case wherein a multiply-accumulate-and-reduce operation on more terms than available SIMD lanes (or parallel multipliers) is considered in more detail, to illustrate the ability to reduce more terms than the number of parallel multipliers. For example, there may be “M” SIMD lanes, wherein M is a positive integer (and more specifically whose value is greater than or equal to 2, pertaining to 2 or more parallel SIMD operations. In particular cases, M can be a power-of-2 or 2̂N, wherein n is a positive integer. In an example multiply-accumulate-and-reduce operation, a number S=M+C terms can be reduced, wherein C is also a positive integer, and represents one or more multiplications in which one of the elements to be multiplied is 1 (e.g., multiplications with a coefficient of 1). The C terms whose coefficients are 1 (e.g., data element Z in the above description) are accumulated or added to the product of M terms calculated by the M multipliers. The C terms are not multiplied by 1 in a multiplier first before being horizontally reduced. Further, horizontal reduction of terms which do not contribute to the result, such as dummy terms (e.g., Q*0 from the above description) is also avoided.

While aspects described herein refer to a data vector comprising data elements and a coefficient vector comprising coefficient elements, it will be understood that the aspects are equally applicable to any two vectors wherein a first vector comprises a first set of elements (e.g., multiplicands, without loss of generality), and a second vector comprises a second set of elements (e.g., corresponding multipliers). The terms data elements and coefficients are used to convey exemplary applications to digital filters. However, exemplary aspects may be applicable to multiply-and-horizontal-reduce operations in other processing applications as well. In one or more aspects, exemplary SIMD implementations of multiply-and-horizontal-reduce operations are described for a first/data vector comprising S=M+C (e.g., 2̂N+C) multiplicand/data elements and a second/coefficient vector comprising S=M+C (e.g., 2̂N+C) corresponding multiplier/coefficient elements wherein C coefficients are 1, or alternatively, M (e.g., 2̂N) coefficient elements with implicit additional C coefficients of value 1. Since the multiply-and-horizontal-reduce operations are implemented with multiply operations followed by accumulation of at least one multiplicand whose coefficient is 1, followed by reduction or accumulation, the exemplary operations are also referred to as multiply-accumulate-and-reduce operations.

The exemplary aspects are explained in further detail below with reference to the figures.

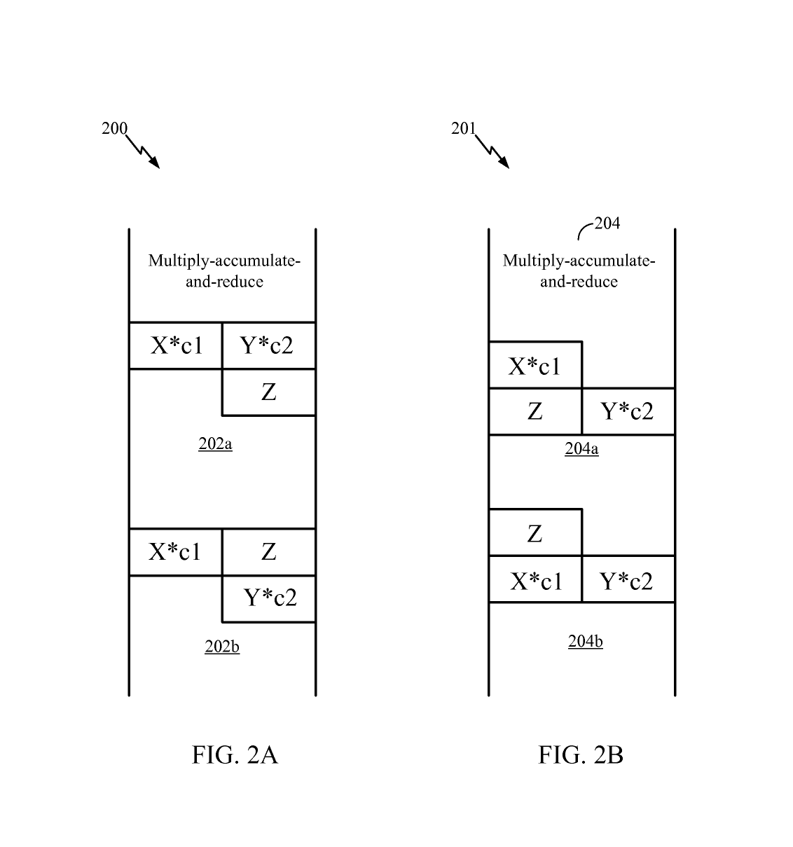

With reference first to FIGS. 2A-B, schematic representations of exemplary aspects are shown. Specifically, FIG. 2A illustrates exemplary implementation 200, which may be implemented by logic in a processor (not shown in this view) configured to implement SIMD instructions, for example. As such, implementation 200 involves receiving a data vector comprising three data elements X, Y, and Z along with a coefficient vector comprising coefficients c1, c2, and either an implied or explicit coefficient of value “1.” In options 202a and 202b of implementation 200, SIMD instructions to calculate X*c1+Y*c2+Z are executed, wherein the element Z is added to Y*c2 in a multiplication-add or multiply-accumulate logic wherein a multiplier is used to compute Y*c2 and with an optimized data path which shares accumulation logic, compressors, adders, etc., with the multiplier, the data element Z is added. In parallel, X*c1 is computed by another multiplier. The results of (Y*c2+Z) and X*c1 are then added together in order to “reduce” the number of terms to the final resulting value of X*c1+Y*c2+Z. In some aspects, the intermediate results of (Y*c2+Z) and X*c1 may be left in a redundant format (e.g., as a pair of sum and carry vectors) and they may be accumulated and added in a full adder (e.g., a carry propagate adder) in a subsequent step. Other variations for including Z in the accumulation or reduction path for X*c1+Y*c2 using multiply-accumulate logic known in the art are also possible within the scope of this disclosure.

The difference between options 202a and 202b may be based on relative positions of the terms Z and Y in the received data vector. For example, based on whether the data elements have a relative order represented as [X, Y, Z] or [X, Z, Y] (with the coefficients following corresponding order in the coefficient vector [c1, c2, 1] or [c1, 1, c2], respectively), options 202a or 202b may be chosen. It will be observed that both of these options effectively perform the same computation to obtain the same result.

With reference to FIG. 2B, implementation 201 is similar to implementation 200, with the variation that Z may be accumulated with X*c1 first and the result of which may be accumulated with Y*c2. Options 204a and 204b may depend on whether the relative order of the terms received in the data vector are [X, Z, Y] or [Z, X, Y], respectively, while keeping in mind that the same results are obtained by either option. Moreover, any of the options 202a, 202b, 204a, and 204b may be chosen depending, for example, on the order in which the terms are received by a SIMD instruction, with the final result being the same, i.e., X*c1+Y*c2+Z.

Thus, exemplary aspects may relate to implementations of SIMD instructions for calculating a sum of S=M+C (e.g., 2̂N+C) product terms wherein C terms have multiplicand operands to be multiplied by a multiplier operand (e.g., a coefficient or weight) whose value is 1, by implementing a multiplication of M (e.g., 2̂N) products in parallel and adding the C multiplicands to the result. In the above examples of FIGS. 2A-B, the value of M=2 (or N=1) and C=1, wherein two parallel multiplications were performed and one multiplicand Z was added.

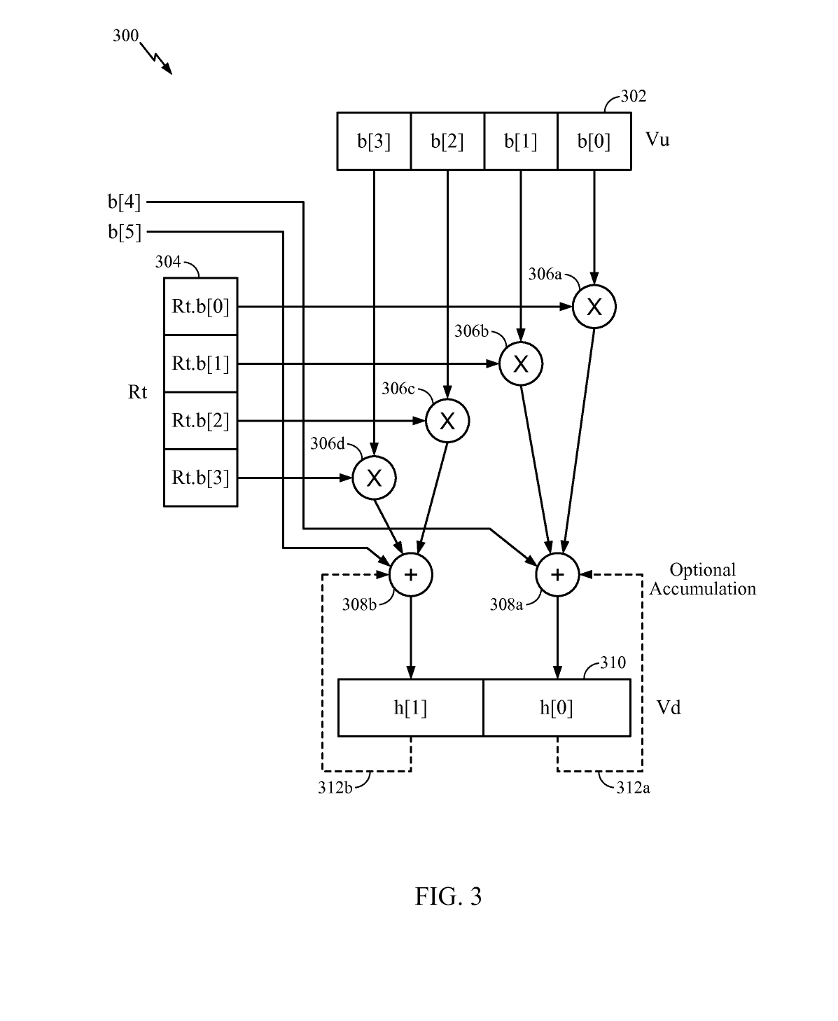

With reference now to FIG. 3, logic 300 is illustrated with reference to an exemplary aspect. Logic 300 may be provided in an apparatus such as a processor (not shown in this view) configured to support four or more SIMD operations on 8-bit wide data elements. The apparatus can also include a memory (not shown in this view). An exemplary SIMD instruction may receive (e.g., from the memory) 32-bit data vector Vuu with eight 8-bit wide data elements. However, only the lower half Vu 302 of Vuu is fully illustrated with four 8-bit elements [3:0], for the purposes of this discussion. Two more 8-bit elements b[5] and b[4] may be derived from the upper half of Vuu, but the upper half of Vuu is not fully illustrated. The additional 8-bit elements b[5] and b[4] may be supplied by a different source if only Vu 302 is provided to logic 300, rather than a 64-bit wide vector Vuu. Also shown is 32-bit coefficient vector Rt 304 with four 8-bit wide elements or coefficients, Rt.b[3]-Rt.b[0] and 32-bit wide result vector Vd 310 with two 16-bit wide results h[1] and h[0]. The vectors Vu 302, Rt 304, and Vd 310 may be logical register names for physical registers of a register file (or other memory, not shown in this view) provisioned in or communicatively coupled to the above-mentioned processor.

In an aspect of logic 300, four multipliers 306a-b are used to perform four parallel 8×8 bit multiplications of 8-bit elements b[3]-b[0] of Vu 302 as multiplicands with 8-bit elements Rt.b[3]-Rt.b[0] as multipliers, in a SIMD manner (as seen, M=4 or N=2 in this case). The four products are split into two groups of two product terms each and additional terms b[5] and b[4] are added to each of these groups respectively. The additional terms are not multiplied by a coefficient, or in other words, are effectively multiplied by an implicit coefficient of 1 (as seen, C=1 in this case).

For instance, in a first operation, multipliers 306a and 306b are used to provide the products b[0]*Rt.b[0] and b[1]*Rt.b[1] (similar to X*c1 and Y*c2 described previously). In some aspects, the products b[0]*Rt.b[0] and b[1]*Rt.b[1] may be available in this stage in a redundant format as known in the art, wherein they are expressed as a pair of sum and carry vectors without being resolved into a final value using a carry-propagate adder, for example. Regardless of their format, b[0]*Rt.b[0] and b[1]*Rt.b[1] are supplied to adder or vertical accumulator 308a. An additional third term b[4] is also supplied to vertical accumulator 308a, which then adds b[0]*Rt.b[0]+b[1]*Rt.b[1]+b[4] and stores the result in element h[0] of result vector 312a. In some aspects, a previous value that was stored in element h[0] (say h[0]_old) of the register comprising result vector 312a may be optionally accumulated (or vertically reduced) in vertical accumulator 308a via path 312a to generate b[0]*Rt.b[0]+b[1]*Rt.b[1]+b[4]+h[0]_old, and the final result may be stored in h[0]. In some cases, h[0]_old may be accumulated with b[0]*Rt.b[0]+b[1]*Rt.b[1] without the additional term b[4], to obtain a different result b[0]*Rt.b[0]+b[1]*Rt.b[1]+h[0]_old which also has the previously described format of X*c1+Y*c2+Z.

Logic 300 is configured to perform a second operation similar to the first operation described above, in parallel with the first operation. Without repeating an exhaustive description of similar processes, the second operation, involves the calculation of b[2]*Rt.b[2]+b[3]*Rt.b[3]+b[5] or b[2]*Rt.b[2]+b[3]*Rt.b[3]+b[5]+h[1]_old using multipliers 306c-d, vertical accumulator 308b, and optional accumulation of h[1]_old through path 312b. Accordingly, the first operation and the second operation may be used to implement multiply-accumulate-and-reduce operations on two sets of three terms using four multipliers.

Although not specifically illustrated, various alternative aspects are possible within the scope of this disclosure. For example, a variation of logic 300 could involve adding the results of all four multipliers 306a-306d in a single accumulator and also adding one additional term, for example, to generate a result, such as, b[0]*Rt.b[0]+b[1]*Rt.b[1]+b[2]*Rt.b[2]+b[3]*Rt.b[3]+b[4]. In this way, 2̂2+1 terms may be reduced with products of 2̂2 multiplications accumulated with one term (which is implicitly multiplied by 1). Variations in terms of bit-widths of operands, number of parallel SIMD computations, bit width of data paths supported, etc., are also similarly possible, to support a wide variety of SIMD instructions.

Accordingly, in one or more aspects discussed above, it is possible to implement a multiply-and-horizontal-reduce operation on a number of S=M+C (e.g., 2̂n+c) terms, wherein C terms are to be multiplied by 1, by implementing M multiplications and accumulating the C terms with the result of the M multiplications.

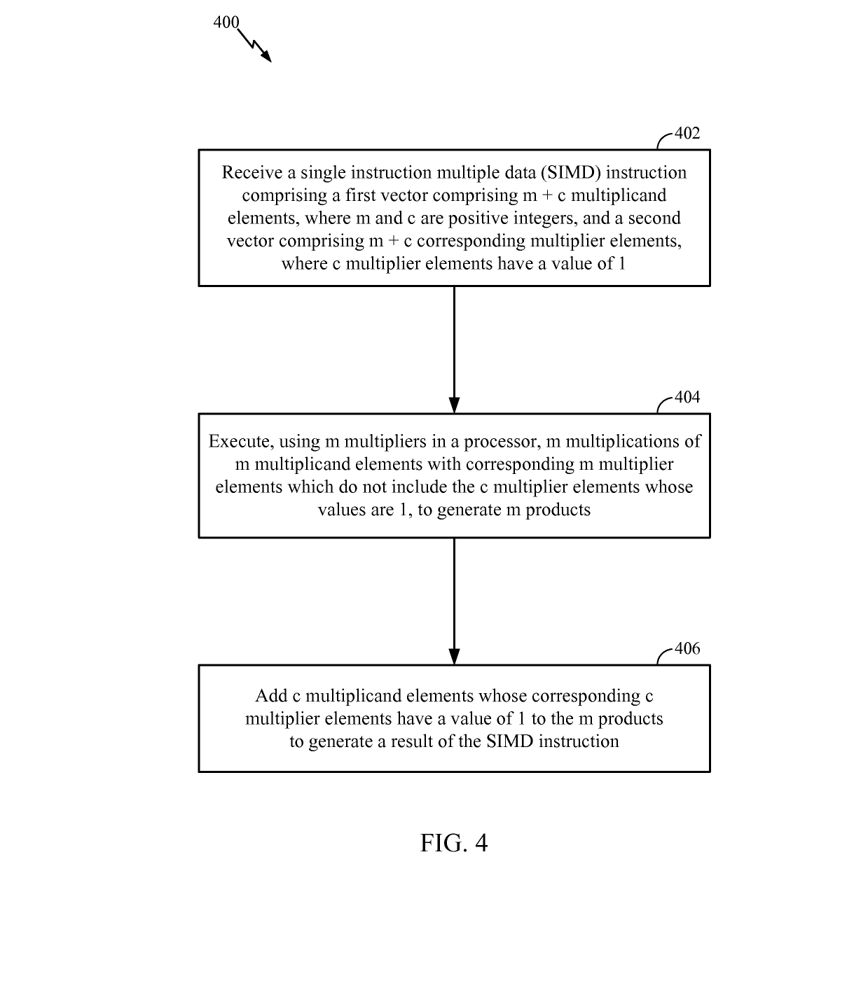

Accordingly, it will be appreciated that aspects include various methods for performing the processes, functions and/or algorithms disclosed herein. For example, as illustrated in FIG. 4, an aspect can include a method 400 of performing a multiply-and-horizontal-reduce operation.

As shown, Block 402 of method 400 comprises: receiving a single instruction multiple data (SIMD) instruction comprising a first vector comprising M+C multiplicand elements, wherein M and C are positive integers (e.g., vector Vu 302 with elements b[0] and b[1] with additional elements supplied by b[4]), wherein M is a positive integer (e.g., 2), and a second vector (e.g., Rt 304 comprising Rt.b[0] and Rt.b[1] with C=1 implied additional coefficients of 1). Block 402 also comprises receiving a second vector comprising M+C corresponding multiplier elements, wherein C multiplier element have a value of 1.

In Block 404, method 400 includes executing, using M multipliers (e.g., 306a-b) in a processor, M multiplications of M multiplicand elements with corresponding M multiplier elements which do not include the C multiplier elements whose values are 1, to generate M products. The M multiplications can be performed in parallel.

In Block 406, method 400 includes adding (e.g., in vertical accumulator 308a) C multiplicand elements (e.g., b[4]) whose corresponding C multiplier elements whose values are 1 to the M products to generate a result of the SIMD instruction. In method 400, M can have a value of 2̂N, wherein N is a positive integer. The value of M can correspond to the maximum number of SIMD lanes supported by a processor implementing the SIMD instruction. Method 400 can, in some aspects, correspond to implementing the multiply-and-horizontal-reduce operation in a digital filter, wherein the multiplicand elements are data elements and the multiplier elements are coefficients or weights corresponding to the data elements.

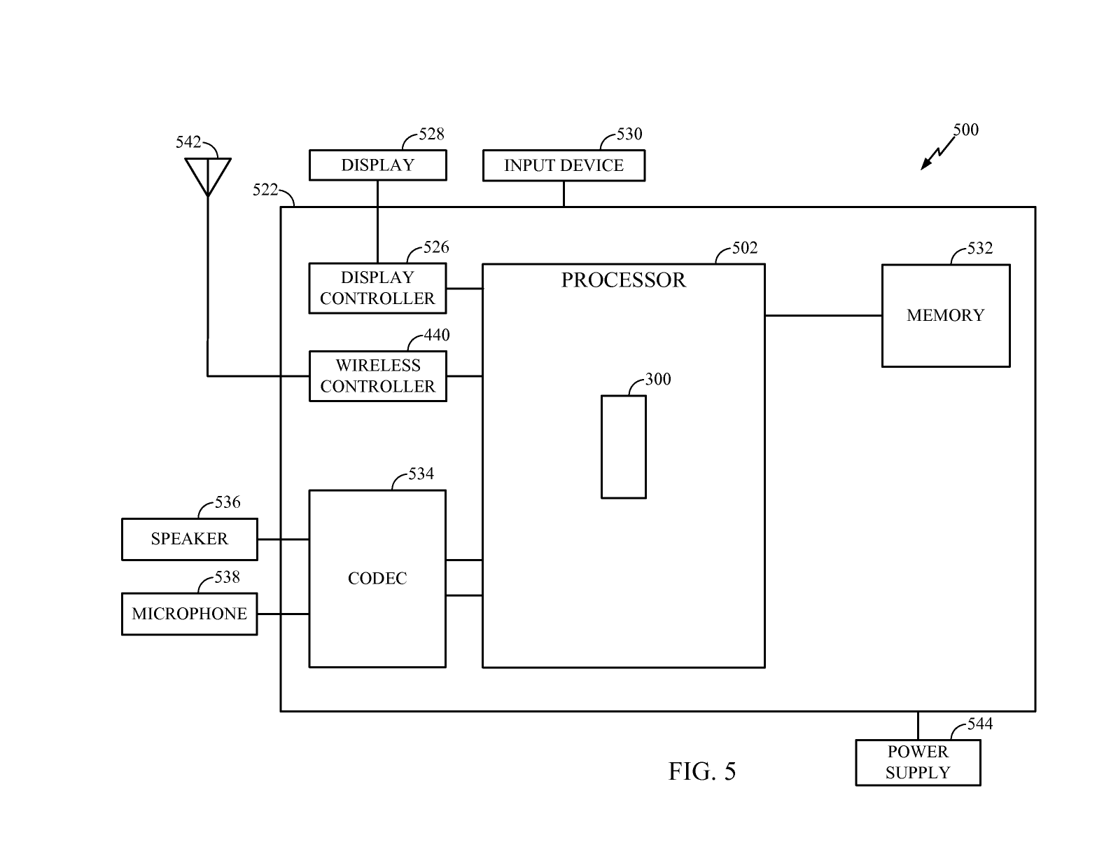

Referring to FIG. 5, a block diagram of a particular illustrative aspect of wireless device 500 according to exemplary aspects. Wireless device 500 includes processor 502, which can comprise logic 300 of FIG. 3 (although details of logic 300 are omitted from this illustration, for the sake of clarity). In exemplary aspects, wireless device 500, and more specifically, processor 502 in some cases, can be configured to perform method 400 of FIG. 4 described above. As shown in FIG. 5, processor 502 may be in communication with memory 532. In some aspects, the values of vectors 302, 304, and 310 may be stored in memory 532 and/or stored in a register file (not shown) provisioned in processor 502. Although not shown, one or more caches or other memory structures may also be included in wireless device 500.

FIG. 5 also shows display controller 526 that is coupled to processor 502 and to display 528. Coder/decoder (CODEC) 534 (e.g., an audio and/or voice CODEC) can be coupled to processor 502. Other components, such as wireless controller 540 (which may include a modem) are also illustrated. Speaker 536 and microphone 538 can be coupled to CODEC 534. FIG. 5 also indicates that wireless controller 540 can be coupled to wireless antenna 542. In a particular aspect, processor 502, display controller 526, memory 532, CODEC 534, and wireless controller 540 are included in a system-in-package or system-on-chip device 522.

In a particular aspect, input device 530 and power supply 544 are coupled to the system-on-chip device 522. Moreover, in a particular aspect, as illustrated in FIG. 5, display 528, input device 530, speaker 536, microphone 538, wireless antenna 542, and power supply 544 are external to the system-on-chip device 522. However, each of display 528, input device 530, speaker 536, microphone 538, wireless antenna 542, and power supply 544 can be coupled to a component of the system-on-chip device 522, such as an interface or a controller.

It should be noted that although FIG. 5 depicts a wireless communications device, processor 502 and memory 532 may also be integrated into a set top box, a music player, a video player, an entertainment unit, a navigation device, a personal digital assistant (PDA), a fixed location data unit, or a computer. Further, at least one or more exemplary aspects of wireless device 500 may be integrated in at least one semiconductor die.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer-readable media embodying a method for performing multiply-and-horizontal-reduce operations. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of performing a multiply-and-horizontal-reduce operation, the method comprising:
receiving a single instruction multiple data (SIMD) instruction comprising:
a first vector comprising M+C multiplicand elements, wherein M and C are positive integers; and
a second vector comprising M+C corresponding multiplier elements, wherein C multiplier elements have a value of 1;
executing, using M multipliers, M multiplications of M multiplicand elements with corresponding M multiplier elements which do not include the C multiplier elements whose values are 1, to generate M products; and
adding C multiplicand elements whose corresponding C multiplier elements have a value of 1 to the M products to generate a result of the SIMD instruction.

2. The method of claim 1, wherein M=2̂N, wherein N is a positive integer.

3. The method of claim 1, further comprising executing the M multiplications in parallel.

4. The method of claim 1, further comprising adding the C multiplicand elements to the M products in a vertical accumulator.

5. The method of claim 1, further comprising vertically accumulating an accumulator value to the result.

6. The method of claim 1, further comprising implementing the multiply-and-horizontal-reduce operation in a digital filter, wherein the multiplicand elements are data elements and the multiplier elements are coefficients or weights corresponding to the data elements.

7. The method of claim 1, wherein the value of M is equal to a number of SIMD lanes.

8. An apparatus comprising:
logic configured to receive a single instruction multiple data (SIMD) instruction first vector comprising M+C multiplicand elements, wherein M and C are positive integers, and a second vector comprising M+C corresponding multiplier elements, wherein C multiplier elements have a value of 1;
m multipliers configured to execute M multiplications of M multiplicand elements with corresponding M multiplier elements which do not include the C multiplier elements whose values are 1, to generate M products; and
a vertical accumulator configured to add C multiplicand elements whose corresponding multiplier elements have a value of 1 to the M products to generate a result of the SIMD instruction.

9. The apparatus of claim 8, wherein M=2̂N, wherein N is a positive integer.

10. The apparatus of claim 8, wherein the M multipliers are configured to execute the M multiplications in parallel.

11. The apparatus of claim 8, wherein the vertical accumulator is further configured to add an accumulator value to the result.

12. The apparatus of claim 8, comprising a digital filter, wherein the multiplicand elements are data elements of the digital filter and the multiplier elements are coefficients or weights corresponding to the data elements.

13. The apparatus of claim 8, wherein the value of M is equal to a number of SIMD lanes.

14. The apparatus of claim 8, integrated into a device selected from the group consisting of a set top box, music player, video player, entertainment unit, navigation device, communications device, personal digital assistant (PDA), fixed location data unit, and a computer.

15. A system comprising:
means for receiving a single instruction multiple data (SIMD) instruction first vector comprising M+C multiplicand elements, wherein M and C are positive integers, and a second vector comprising M+C corresponding multiplier elements, wherein C multiplier elements have a value of 1;
means for executing M multiplications of M multiplicand elements with corresponding M multiplier elements which do not include the C multiplier elements whose values are 1, to generate M products; and
means for adding C multiplicand elements whose corresponding multiplier elements have a value of 1 to the M products to generate a result of the SIMD instruction.

16. The system of claim 15, wherein M=2̂N, wherein N is a positive integer.

17. The system of claim 15, wherein the means for executing M multiplications comprises means for executing the M multiplications in parallel.

18. The system of claim 15, further comprising means for adding an accumulator value to the result.

19. A non-transitory computer-readable storage medium comprising instructions executable by a processor, which when executed by the processor cause the processor to perform a multiply-and-horizontal-reduce operation, the non-transitory computer-readable storage medium comprising:
code for receiving a single instruction multiple data (SIMD) instruction first vector comprising M+C multiplicand elements, wherein M and C are positive integers, and a second vector comprising M+C corresponding multiplier elements, wherein C multiplier elements have a value of 1;
code for executing, using M multipliers, M multiplications of M multiplicand elements with corresponding M multiplier elements which do not include the C multiplier elements whose values are 1, to generate M products; and
code for adding C multiplicand elements whose corresponding C multiplier elements have a value of 1 to the M products to generate a result of the SIMD instruction.

20. The non-transitory computer-readable storage medium of claim 19, further comprising code for adding an accumulator value to the result.
